(19) United States
(12) Patent Application Publication
(10) Pub. No.: US 2011/0165270 A1
(43) Pub. Date: Jul. 7, 2011

(54) Environmentally-friendly substratum composition for a variety of personal products

(76) Inventor: Daryl Jean Glinn-Tanner, Tujunga, CA (US)

(21) Appl. No.: 12/655,779

(22) Filed: Jan. 7, 2010

(51) Int. Cl. C09K 15/34; A01N 65/00

(52) U.S. Cl. 424/725; 252/398

(57) ABSTRACT

A substratum composition derived entirely from naturally occurring ingredients chosen for their detoxifying, cleansing, and rejuvenating properties, and blended in effective proportions. Additionally, composition constituents are scrutinized and screened for environmental neutrality, thereby eliminating traditional impacts on community watersheds. The all-natural composition may serve as a substratum for a variety of personal hygiene, haircare, skincare, and cosmetic products.

### CROSS-REFERENCE TO RELATED APPLICATIONS

This application is based on, and claims priority from, a provisional patent filed on Jan. 6, 2009 titled “T.H.E. C.O.R.E.: Toxic Halting Enhancer; Clay Organics Restoring Environments” that was subsequently assigned the Ser. No. 61/204,375.

### FIELD OF THE PRESENT DISCLOSURE

This disclosure relates generally to compositions designed to cleanse and detoxify, and more particularly to a substratum composition comprising an aqueous clay solution blended with naturally derived anti-fungals, anti-bacterials, antioxidants, and waxes, to form a base for a variety of environmentally friendly health promoting personal products.

### BACKGROUND OF THE RELATED ART

Many commercially available personal hygiene, haircare, skin care, and cosmetic products are synthesized with chemicals and reagents far too caustic and reactive for repetitive contact with the body. Use of these products over time strips the skin and hair of their natural emollients, thus accelerating aging and necessitating the use of moisturizers and conditioners to replace the body's natural oils which, often contain additional harsh synthetic chemicals.

For example, the active ingredient in many shampoos is sodium lauryl sulfate, a chemical synthesised by reacting lauryl alcohol with sulfuric acid and subsequently neutralized by sodium carbonate. This powerful reagent is utilized because it possesses strong amphiphilic properties (possessing both water-loving and lipid-loving properties) allowing it to bond to the oils on the hair and skin while remaining soluble in water, thereby enabling the oils to be carried away, emulsified in water. This may seem advantageous at first blush; however, it is the strength of the chemical that is problematic. Sodium lauryl sulfate is so amphiphilic that it is also used as an engine degreaser or industrial floor cleanser. When used in personal products, it often removes the oils both on the hair and the skin and in the hair and the skin.

Use of this powerful reagent in personal hygiene products has been linked to a variety of skin-related health concerns, even when used in small quantities. Many studies have support these concerns, recommending that individuals avoid prolonged exposure to products containing sodium lauryl sulfate. However, this recommendation is difficult to heed because the chemical is ubiquitous in traditional commercially available products.

There are many other reagents of questionable safety that consumers are virtually inundated with. Another prominent example is propylene glycol. This reagent is commonly used as a moisturizer in medicines, cosmetics, food, toothpaste, and mouthwash, as a carrier for fragrances, and as a main ingredient in many deodorants. It is not surprising that propylene glycol raises health concerns when considering its other uses such as the working fluid in hydraulic presses, coolant in internal combustion engines, and the active reagent products designed to de-ice aircrafts. There is a strong need for a line of products that utilize safer, gentler and more natural active ingredients.

A still further example of the widespread commercial use of potentially harmful substances is the class of chemicals called parabens. Parabens are esters of para-hydroxybenzoic acid that are widely used as preservatives in cosmetic and pharmaceutical products for their bactericidal and fungicidal properties. Parabens are popular primarily because they are cheap, not because they are undeniably safe. There is current controversy as to the role parabens in external hygiene products play in the development of cancer, especially breast cancer. One would think this is reason enough to explore acceptable alternatives.

Additionally, it is important to note, that the potential harm these powerful reagents cause is not limited to the health of those individuals who choose to utilize the personal products in which they are incorporated. When consumers of the aforementioned products bathe, these toxic reagents are washed down the drain into our grey water systems and are collected at municipal water treatment plants. There, the grey water is treated and released into our rivers, streams, aquifers, and oceans. Some water treatment plants are able to breakdown harmful substances while others cannot, or choose not to invest in the required technology. Still other harmful substances find their way directly into watersheds, bypassing water treatment plants by way of spills, pipe breaks, or careless behavior. The result is the same. Our rivers, streams, aquifers, and oceans and even the plants and animals grown for human consumption are increasingly becoming contaminated with a large variety of unhealthy substances. This cycle can be mitigated by reducing or discontinuing use of such substances.

The present disclosure addresses this issue and distinguishes over the related art providing heretofore unknown advantages as described in the following summary.

### DESCRIPTION OF AN EXEMPLARY EMBODIMENT OF THE INVENTION

The present disclosure describes a synthetic-free composition comprising an aqueous clay solution blended with select naturally derived antifungals, antibacterials, antioxidants found in herbs, essential oils, and waxes titled T.H.E. C.O.R.E.: Toxin Halting Enhancer; Clay Organics Restoring Environments. The composition serves as a detoxifying health promoting substratum for a variety of personal products including, but not limited to, hair and body wash, toner, gel, spray, lotion, mousse, shampoo, conditioner, hair and body dye (including oxidative dyes, bleaches, permanent waving compositions, curl relaxing compositions, hair setting compositions), sunscreens, and cosmetics (including mascara and foundations).

The primary ingredient is a montmorillonite-like clay or bentonite-like clay. Bentonite™ is a commercial name for name for clay containing high concentrations of the mineral montmorillonite such as the clay found in and around the city Montmorillon, France. Montmorillonite clay is highly porous, and is composed of a mass of tiny polar platelets that have the ability to attract toxins such as herbacides, pesticides, heavy metals, and others through two separate mechanisms; adsorption and surface precipitation.

Additionally, montmorillonite clay is ideal for stabilizing suspensions and emulsions and it serves as an excellent excipient. Further, it exhibits variable viscosity depending on hydration, which makes it an excellent substratum. A preferred substratum composition consists of up to 49.25% montmorillonite-like aqueous clay by weight.

Further, a preferred embodiment of the disclosed substratum composition includes up to 49.25% by weight of a variable, unlimited blend of herbs, essential oils, and waxes chosen for both health promoting properties and low environmental impact. So long as each embodiment includes at least one plant-derived anti-fungal, antioxidant, or antibacterial in a sufficient quantity to allow at least one natural, non-synthetic wax to be incorporated.

In some embodiment the presently disclosed substratum composition contains a natural, plant derived preservative. It is preferred that the preservative does not exceed 0.5% of the composition by weight.

It has been found that the disclosed substratum composition is most effective when comprises between 7% and 14% of the finished product to achieve most desired results.

The following are preferred ingredients that may be included in varying proportions:

Aloe Barbadinsis Leaf Extract (Aloe Vera) is a species of succulent that demonstrates a plethora of medicinal purposes. Its most prominent benefit relates to the skin and skin disorders. The plant is used to treat cuts, burns, bruises, eczema, acne, inflammation, nondescript skin irritations, and generally sooths and rejuvenates skin. Additionally, it serves as a carrier for other herbs and essential oils.

Equisetum Hyemale Extract (Horsetail or Shavegrass) is a natural astringent and calmative, rich with trace elements. It is used for aiding the healing of bruised and cut flesh, bone, and cartilage. It is also used for skin disorders including eczema and acne and pain relief.

Laminaria Saccharine Extract (Blue green Algae) is an antioxidant, rich in vitamins and amino and fatty acids known to nourish hair, skin, and nails while also acting as a environmentally friendly colorant.

Scutellaria Galericulata Extract (Skullcap) is a hardy perennial herb in the mint family used to reduce and even stimulate hair growth. It is also used as a mild sedative.

Humulus Lupulus Extract (Hops) is a natural skin moisturizer and softener derived from the female flower that is used to treat rashes and hives. It is also known to stimulate collegen production.

Carum Petroselinum Extract (Parsley) is an herb extract known to slow the thinning of hair and as to act as a biologically harmless colorant.

Urtica Dioica Extract (Nettle) is a natural circulation and cell stimulant that aids in soothing a variety of skin disorders such as eczema and acne. It is also know to provide mild pain relief.

Arctium Jajus Extract (Burdock Root) is a natural detoxifier derived from a biennial thistle, thought to rid hair follicles of calcium and heavy metal deposits. It is also a known treatment for skin disorders such as acne, eczema, rosacea, and psoriasis.

Mentha Piperita Extract (peppermint) is an herb with natural anti-inflamatory and antiseptic qualities. Additionally, it is known to ameliorate skin irritation and is thought to stimulate hair growth.

Achillea Millefolium Extract (Yarrow) is associated with aiding in the treatment of a large variety of ailments. Most notably it is believed to increase circulation, thereby reducing hair loss. It is also credited with the ability to moisturize, soften, and sooth the skin.

Hibiscus Rosa Sinensis (Hibiscus) is an evergreen flowering shrub, extracts from which have antibacterial and anti-parasitic qualities. It is also known for its ability to moisturize and soothe the scalp, hair follicles, and skin.

Avena Sativa Extract (Oatstraw) is a common grain, known to be rejuvenative and calming, and it is rich with minerals that nourish bones, skin, hair, and nails.

Yucca Schidigera (Yucca) is a natural surfactant, important in the production of environmentally safe soaps. It also is known to break down organic wastes.

Gentiana Lutea Extract (Gentian Root) is known to aid in the absorption of minerals and vitamins, especially iron and B12. It also possesses antiseptic qualities.

Silybum Marianum Extract (Milk Thistle) is a perennial plant with a root that contains natural antioxidants that have the ability to protect the liver by detoxifying alcohol and other chemical poisons. It is also known for its ability to stimulate protein synthesis.

Guar Gum is a natural emulsifier and stabilizer with the ability to absorb toxins. It is produced by grinding the endosperm of guar beans.

Lonicera Caprifolium/Japonica Flower Extract (Honeysuckle) is used as a natural, environmentally friendly preservative. The active reagent is found in the plant's flower.

Limnanthes Alba (Meadowfoam) is an essential oil with preservative qualitative. It also has the ability to extend the preservative qualities of other oils with which it is mixed.

Simmondsia Chinensis (Jojoba Seed) is a desert shrub known for the liquid oil in its seeds. This oil is rare in that it is an extremely long, straight chain wax ester and not a triglyceride, making jojoba and its derivative esters more similar to human sebum that traditional vegetable oils. Jojoba oil is easily refined to be odorless, colorless and oxidatively stable and therefore an excellent delivery systems for other oils and extracts. Because of its similarity to sebum, jojoba oil is particularly effective in treating a variety of skin disorders.

Rosa Canina Fruit (Rose Hip Seed) is species of rose also known for the liquid oil in its seeds. Rose hip's seed oil is hypoallergenic and has the ability to moisturize particularly sensitive, mature, aging problem skin. It is also known to treat inflammation, wrinkles, and both prevent and fade stretch marks. It is rich with vitamins, particularly C, E and derivative of A.

Borago Officinalis (Borage Seed) is an annual herb that is rich with gamma-linolenic acid and is used to slow the aging process of the skin. It also is successful in aiding the healing of wounds and treating a variety of skin disorders such as dry skin, dermatitis, eczema, inflammation, psoriasis as well as dandruff.

Oenothera Biennis (Evening of Primrose) is a flowering plant, also rich with gamma-linolenic acid and is used to slow the aging process of the skin. Like borage seed, it is successful in aiding the healing of wounds and treating a variety of skin disorders such as dry skin, dermatitis, eczema, inflammation, psoriasis, and dandruff.

Persea Gratissima (Alvocado) is a fruit that contains a light oil that is beneficial to the skin in many ways, including treating rashes and age spots, healing wounds, reducing inflammation, and mitigating dermatitis, and moisturizing the skin. It is also rich in vitamins, mineral, and nutrients such as vitamins A, C, D, and E, beta-carotene, potassium, lecithin, fatty acids and other proteins.

Oryza Sativa (Rice Bran) is species of rice from which an oil can be extracted that is rich in vitamin E and serves as a powerful antioxidant. It is ideal for hair products intended for individuals with fine hair because of its light texture.

Panthenol (Vitamin B5) is the alcohol analog of pantothenic acid and thus the provitamin B5. It serves an excellent humectant, emollient, and moisturizer.

Tocopheryl Acetate (Vitamin E) is the ester of acetic acid and tocopherol (Vitamin E). It is thought that it provides protection for the skin from the sun's ultraviolet rays.

Citric Acid or Ascorbic Acid (Vitamin C) is a weak organic acid that is rich in vitamin C.

Quillaja Saponaria (Soap Bark) is an evergreen tree with bark that may be used as a soap after it is reduced to a power. It is harmless if ingested and is often used as a food or pharmaceutical additive as well.

The above-mentioned list of herbs, plant derivatives, essential oils, and waxes are offered for purposes of example and are not intended to be limiting. Additional, ingredients may be incorporate so long as they are non-synthetic and the herb, plant derivative, or essential oil, portion of the substratum does not exceed 49.25% of the substratum composition by weight.

In addition to the variety of different health, nourishing and detoxifying benefits that the disclosed substratum composition offers consumers of a personal product in to which it is incorporated, the substratum composition offers benefits to our environment. Such benefits begin with our water systems because, when the above mentioned blend of ingredients are washed down the drain of the consumers sink, shower, or tub, it continues to absorb and neutralize the toxins it comes in to contact with, thereby cleansing the grey water as it travels to the municipal water facility. While this may only be a small impact on the waste water systems, it is certainly a step in the right direction. Further, and perhaps more importantly, when pipes break, leak, or waste water is released directly into a watershed, the disclosed substratum composition works to absorb and coalesce toxic materials, thus helping to purify our rivers, streams, aquifers, and oceans.

While the disclosed substratum composition is primarily designed for personal products, it serves to purify our environment if it is incorporated in to household products as well as products such as fruit and vegetable cleaners, laundry detergents; dishwashing detergents, glass and bathroom cleaners. As before, this list is offered for purposes of example and is not intended to be limiting.

This disclosure teaches certain benefits in construction and use which give rise to the objectives described below.

A primary objective inherent in the above-described composition is to provide advantages not taught by the prior art.

Another objective is to provide an a substratum composition for a variety of personal products designed to be gentler and healthier than what is traditionally commercially available.

A further objective is to provide an effective substratum composition comprised of non-synthetic, non-toxic, naturally derived products designed to detoxify and promote the health of the consumer.

A still further objective, is to provide a substratum composition comprised of non-synthetic, non-toxic, naturally derived products designed to detoxify and promote the health of the environment.

The above description of the disclosed substratum sets forth an exemplary embodiment of the composition and its method of use in at least one of its preferred, best mode embodiments. Those having ordinary skill in the art may be able to make alterations and modifications to what is described herein without departing from the spirit and scope of the disclosure. Therefore, it must be understood that what is illustrated is set forth only for the purposes of example and that it should not be taken as a limitation in the scope of the presently disclosed substratum composition.

The enablements described in detail above are considered novel over the prior art of record and are considered critical to the operation of at least one aspect of the composition, and to the achievement of the above-described objectives. The words used in this specification to describe the instant embodiments are to be understood not only in the sense of their commonly defined meanings, but also to include special definitions disclosed in this specification. Thus, if an element can be understood in the context of this specification as including more than one meaning, then its use must be understood as being generic to all possible meanings supported by the specification and by the word(s) describing the presently disclosed substratum composition.

The definitions of the words, and elements described herein are meant to include not only the combination of elements which are literally set forth, but all equivalent compositions, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is described above, what is conceptually equivalent, what can be obviously substituted, and also what incorporates the essential ideas.

The scope of this description is to be interpreted only in conjunction with the appended claims and it is made clear, here, that the inventor believes that the claimed subject matter is what is intended to be patented.

What is claimed is:

1. A substratum composition comprising:
a.) at least one aqueous clay solution not exceeding 49.25% of said substratum composition by weight;
b.) at least one plant derived non-synthetic anti-fungal, antibacterial, or antioxidant;
c.) at least one non-synthetic wax, said plant derived non-synthetic anti-fungal, antibacterial, or antioxidant and said non-synthetic wax together not to exceed 49.25% of said substratum composition by weight.

2. A substratum composition as in claim 1 further comprising:
a.) at least one plant derived, non-synthetic surfactant.

3. A substratum composition as in claim 2 further comprising:
a.) at least one plant derived, non-synthetic preservative, said plant derived, non-synthetic preservative not to exceed 0.5% of said substratum composition by weight.

4. A substratum composition as in claim 1 wherein:
said aqueous clay is a montmorillonite-like clay.

5. A substratum composition as in claim 3 wherein:
Said plant derived, non-synthetic preservative is either Lonicera Caprifolium or Limnanthes Alba.

6. A substratum composition as in claim 1 wherein:
said non-synthetic was is Simmondsia Chinensis.
